(19) United States
(12) Patent Application Publication
(10) Pub. No.: US 2026/0141891 A1
(43) Pub. Date: May 21, 2026

(54) METHOD, DEVICE AND STORAGE MEDIUM FOR AN AUDIO CONVERSATION

(71) Applicants: Beijing Zitiao Network Technology Co., Ltd., Beijing (CN); Lemon Inc., Grand Cayman (KY); Tsinghua University, Beijing (CN)

(72) Inventors: Wenyi YU, Beijing (CN); Siyin WANG, Beijing (CN); Xianzhao CHEN, Beijing (CN); Xiaohai TIAN, Singapore (SG); Guangzhi SUN, Beijing (CN); Jun ZHANG, Beijing (CN); Lu LU, Los Angeles, CA (US); Yuxuan WANG, Los Angeles, CA (US); Chao ZHANG, Beijing (CN)

(21) Appl. No.: 19/390,371

(22) Filed: Nov. 14, 2025

(30) Foreign Application Priority Data
Nov. 15, 2024 (CN) 202411639147.5

(51) Int. Cl. G10L 13/027; G10L 13/047

(52) U.S. Cl. CPC G10L 13/027; G10L 13/047

(57) ABSTRACT

Embodiments of the disclosure provide a method, apparatus, device, storage medium, and program product for an audio conversation. The method includes: encoding, by a streaming audio encoder, a first audio stream acquired from an environment into an audio feature sequence; generating, by a trained machine-learning model, a text unit sequence based on a system prompt and the audio feature sequence as a response to the first audio stream; and generating, by a streaming audio synthesizer, a second audio stream from the text unit sequence for playback in response to the text unit sequence satisfying an audio synthesis condition.

### CROSS-REFERENCE

This application claims the benefit of Chinese Patent Application No. 202411639147.5, filed on Nov. 15, 2024, entitled “METHOD, APPARATUS, DEVICE AND STORAGE MEDIUM FOR AN AUDIO CONVERSATION,” the entire content of which is incorporated herein by reference.

### TECHNICAL FIELD

Example embodiments of the present disclosure generally relate to the field of computer technologies, and in particular, to a method, apparatus, device, and computer-readable storage medium for speech interaction.

### BACKGROUND

An audio conversation is a manner of human-computer interaction (HCl). With the development of information technologies, more and more applications or platforms and the like provide an audio conversation function. The audio conversation function specifically relates to a text-to-speech (TTS) function (also referred to as a speech synthesis function), an automatic speech recognition (ASR) function (also referred to as a speech-to-text function), and a response function. An application or platform with audio conversation function may provide the audio conversation function to a user by means of a trained machine-learning model.

### SUMMARY

In a first aspect of the present disclosure, a method for an audio conversation is provided. The method includes: encoding, by a streaming audio encoder, a first audio stream acquired from an environment into an audio feature sequence; generating, by a trained machine-learning model, a text unit sequence based on a system prompt and the audio feature sequence as a response to the first audio stream; and generating, by a streaming audio synthesizer, a second audio stream from the text unit sequence for playback in response to the text unit sequence satisfying an audio synthesis condition.

In a second aspect of the present disclosure, an apparatus for an audio conversation is provided. The apparatus includes: an audio encoding module configured to encode, by a streaming audio encoder, a first audio stream acquired from an environment into an audio feature sequence; a text generating module configured to generate, by a trained machine-learning model, a text unit sequence based on a system prompt and the audio feature sequence as a response to the first audio stream; and an audio generating module configured to generate, by a streaming audio synthesizer, a second audio stream from the text unit sequence for playback in response to the text unit sequence satisfying an audio synthesis condition.

In a third aspect of the present disclosure, an electronic device is provided. The device includes at least one processor; and at least one memory coupled to the at least one processor and storing instructions for execution by the at least one processor, the instructions, when executed by the at least one processor, causing the device to perform the method of the first aspect.

In a fourth aspect of the present disclosure, a computer-readable storage medium is provided. The medium has computer instructions stored thereon, the computer instructions, when executed by a processor, implementing the method of the first aspect.

In a fifth aspect of the present disclosure, a computer program product is provided. The computer program product includes a computer program, the computer program, when executed by a processor, implementing the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure can be implemented;

FIG. 2 illustrates a schematic diagram of an example architecture for an audio conversation according to some embodiments of the present disclosure;

FIG. 3 illustrates an example of audio generation according to some embodiments of the present disclosure;

FIG. 4 illustrates an example of an audio synthesis model according to some embodiments of the present disclosure;

FIG. 5 shows a flowchart of a method for an audio conversation according to some embodiments of the present disclosure;

FIG. 6 illustrates an example structural block diagram of an apparatus for an audio conversation according to some embodiments of the present disclosure; and

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for example purposes only and are not intended to limit the scope of the present disclosure.

In the description of the embodiments of the present disclosure, the terms ‘including’, and the like should be understood to include ‘including but not limited to’. The term ‘based on’ should be understood as ‘based at least in part on’. The terms ‘one embodiment’ or ‘the embodiment’ should be understood as ‘at least one embodiment’. The term ‘some embodiments’ should be understood as ‘at least some embodiments’. Other explicit and implicit definitions may also be included below.

It may be understood that the data involved in the technical solution (including but not limited to the data itself, the obtaining or use of the data) should follow the requirements of the corresponding laws and regulations and related regulations.

It may be understood that, before the technical solutions disclosed in the embodiments of the present disclosure are used, the types of personal information related to the present disclosure, the usage scope, the usage scene and the like should be notified to the user in an appropriate manner according to the relevant laws and regulations, and the creation of the user is obtained.

For example, in response to receiving an active request from a user, prompt information is sent to the user to explicitly prompt the user that the requested operation will need to obtain and use personal information of the user, so that the user may autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select ‘agree’ or ‘disagree’ to provide personal information to the electronic device.

It may be understood that the foregoing notification and obtaining a user creation process are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine-learning model,” a “learning model,” a “machine learning network,” or a “learning network,” which terms are used interchangeably herein.

A “neural network” is a deep learning-based machine learning network. The neural network is capable of processing inputs and providing corresponding outputs, which typically include an input layer and an output layer and one or more hidden layers between the input layer and the output layer. Neural networks used in deep learning applications typically include a plurality of hidden layers, increasing the depth of the network. Each layer of the neural network is connected in sequence, thus the output of the previous layer is provided as an input to the next layer, where the input layer receives the input of the neural network, and the output of the output layer serves as the final output of the neural network. Each layer of the neural network includes one or more nodes (also referred to as a processing node or neuron), each node processing input from the previous layer.

Generally, machine learning includes three phases: a training phase, a testing phase, and an application phase (also referred to as an inference phase). At the training phase, a given model may be trained using a large amount of training data, iteratively updating parameter values until the model is able to obtain consistent reasoning from the training data that satisfies the expected targets. By training, the model may be considered to be able to learn, from the training data, an association from input to output (also referred to as mapping of input to output). The parameter values of the trained model are determined. In the testing phase, the test input is applied to the trained model to test whether the model can provide the correct output, thereby determining the performance of the model. The testing phase may sometimes be fused into a training phase. In the application or inference phase, the trained model may be used to process the actual model input based on the parameter value obtained by training, to determine a corresponding model output.

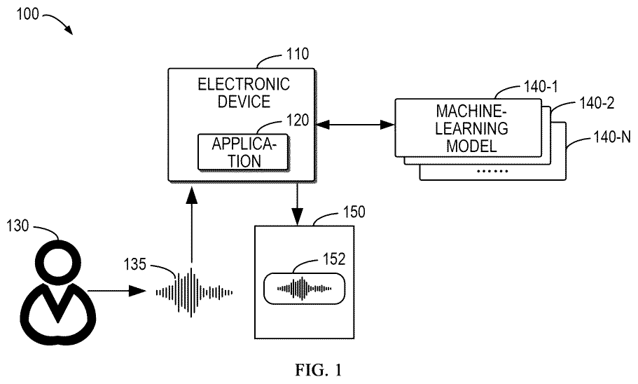

FIG. 1 illustrates a schematic diagram of an example environment 100 in which embodiments of the present disclosure can be implemented. In this example environment 100, an application 120 is installed in the electronic device 110. A user 130 may interact with the application 120 via the electronic device 110 and/or an attachment device of the electronic device 110. For example, the application 120 may acquire a speech 135 of the user 130 via a speech acquisition device (e.g., a microphone) of the electronic device 110.

In an embodiment of the present disclosure, the application 120 may be any suitable application having a human-computer conversation function. For example, the application 120 may provide a digital assistant for human-computer conversation. The digital assistant supports content conversation in text conversation services, speech interaction services, and other modalities with the user 130. In some embodiments, the application 120 or the digital assistant therein may utilize the machine-learning model 140 (which may include one or more machine-learning models, such as may include a machine-learning model 140-1, a machine-learning model 140-2, . . . , a machine-learning model 140-N, and so forth, where N is a positive integer. For convenience of description, the one or more machine-learning models are collectively referred to herein as the machine-learning model 140) to support interaction with the user 130. For example, the application 120 or the digital assistant therein may utilize the one or more machine-learning models 140 to provide a question-and-answer service to the user 130. In a scene of audio conversation, the question in a question-and-answer process is the audio input by the user, and the response is likewise played to the user in an audio form.

In the environment 100, if the electronic device application 120 is active, the electronic device 110 may present a user interface 150 of the application 120. The user interface 150 may include various pages that can be provided by the application 120, such as a conversation page of a user with a digital assistant (where a current conversation and a historical conversation may be presented, including text conversation content), and so forth. In some embodiments, the electronic device 110 may play a speech 152 in the user interface 150. The speech 152 may include, for example, a speech 135 from the user 130 or a speech for a response of a speech 145.

The machine-learning model 140 may be a different type of model. In some embodiments, the one or more machine-learning models 140 may be constructed based on a language model (LM). The machine-learning model used is a content generative model capable of generating a corresponding output based on a model input. In some embodiments, the language-model-based machine-learning model is capable of receiving model inputs in a text modality (for example, natural language and/or machine language) and/or model inputs in a non-text modality (for example, images, speech, video, etc.), and is capable of generating a desired output based on the model input and a prompt. The prompt herein is used to guide the machine-learning model to generate an output that resolves the user requirement indicated by the model input. In an application scene supporting user conversation, an input of the user 130 may be provided to the machine-learning model 140 as at least a portion of the model input (other portions may include prompts). This user input is treated as a question. Based on the model output, a corresponding response may be generated to provide to the user 130.

In FIG. 1, the electronic device 110 may be any type of device having computing capability, including a terminal device or a server device. The terminal device may be any type of mobile, fixed, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a game device, or any combination of the foregoing, including accessories and peripherals of these devices or any combination thereof. The server device may include, for example, a computing system/server, such as a mainframe, an edge-computing node, a computing device in a cloud environment, and the like.

It should be understood that the structure and function of the environment 100 is described for example purposes only and does not imply any limitation to the scope of the present disclosure.

As mentioned above, an audio conversation function specifically involves a TTS function, an ASR function, and a response function. An application or platform with the audio conversation function can provide an audio conversation function to a user by means of a trained machine-learning model. A machine-learning model with a response function is usually based on a user's question text to determine a corresponding response text, which is usually based on a language model. The conventional language model cannot directly process and generate audio, cannot directly determine the corresponding response based on the question (i.e., asking speech) of the audio type from the user, and cannot output the response of the audio type. That is, the audio conversation cannot be implemented based only on the language model. Thus, an application or platform with an audio conversation function typically also needs to assist the language model in implementing an audio conversation with a machine-learning model having a TTS function and ASR function, which can affect the efficiency and performance of the audio conversation.

In addition, traditionally, the language model usually outputs a corresponding response text based on a piece of question text, and in the process of outputting the response text, it cannot receive a question of a new input, that is, it is unable to achieve a full-duplex streaming audio response. This may affect the performance of the audio response.

In view of this, according to embodiments of the present disclosure, an improved solution of an audio conversation is provided. According to this solution, a first audio stream acquired from an environment is encoded, by a streaming audio encoder, into an audio feature sequence. A text unit sequence is generated, by a trained machine-learning model, based on a system prompt and the audio feature sequence as a response to the first audio stream. A second audio stream is generated, by a streaming audio synthesizer, from the text unit sequence for playback in response to the text unit sequence satisfying an audio synthesis condition. Thus, a machine learning model can understand and generate audio in a full-duplex, streaming manner, without introducing discrete audio encoding. This may improve the performance and efficiency of the audio conversation.

Some example embodiments of the present disclosure will be described below with continued reference to the accompanying drawings.

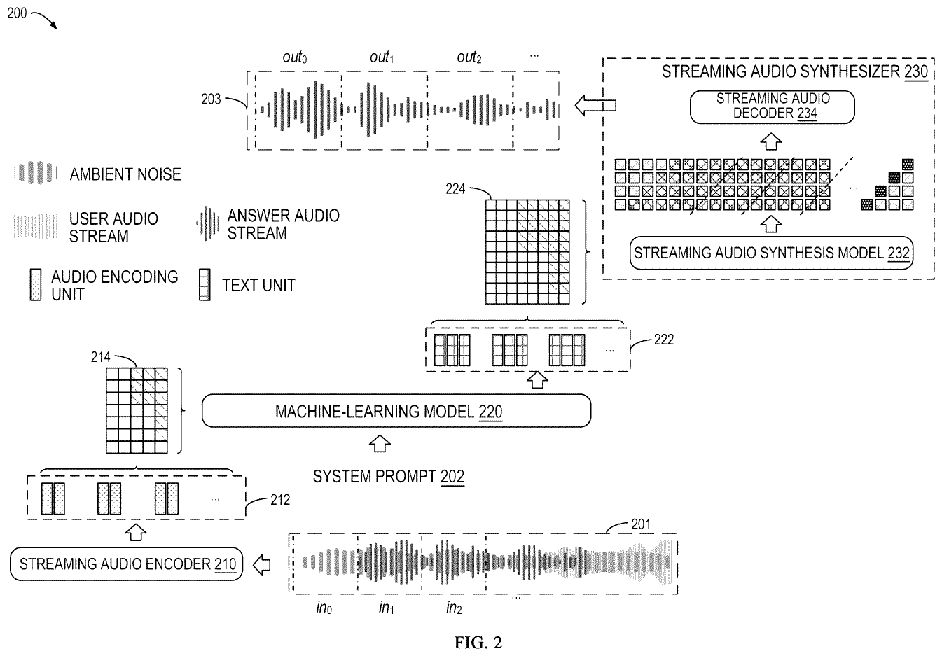

FIG. 2 illustrates a schematic diagram of an example architecture 200 for an audio conversation according to some embodiments of the present disclosure. The example architecture 200 may be implemented at the electronic device 110. For ease of discussion, the example architecture 200 will be described with reference to the environment 100 of FIG. 1. It should be noted that the operations performed by the electronic device 110 and the operations performed by the electronic device 110 described subsequently may be specifically performed by a related application (for example, an application 120) installed on the electronic device 110. In some embodiments, when the electronic device 110 is a terminal device, the operations performed on the electronic device 110 may be completed with the assistance of other devices (for example, a server).

The example architecture 200 includes a streaming audio encoder 210, a trained machine-learning model 220, and a streaming audio synthesizer 230. The streaming audio encoder 210 may be configured to encode an audio stream 201 (referred to herein as a “first audio stream” 201) acquired from an environment into an audio feature sequence 212.

In embodiments of the present disclosure, it is desirable to provide full-duplex audio conversation capabilities. Full-duplex refers to allowing audio to be transmitted simultaneously in two directions, which in an audio conversation scene means that the user's audio input is continuously monitored while the audio response is being output. An audio acquirer may generally be configured for continuous acquisition of audio from the environment. In some embodiments, the audio acquisition may be performed continuously after the audio conversation is initiated, and may stop after the audio conversation is turned off. In some embodiments, depending on the specific ambient conditions, the acquired first audio stream 201 may include at least ambient noise (which may also be referred to as background noise, ambient audio, noise, etc.) and questioning speech from the user. Certainly, if the audio response is being played at this time, the acquired first audio stream 201 may further include an output audio response. It may be understood that the questioning speech may be of any appropriate duration, in any language, and with any timbre.

Since in a full-duplex audio conversation scene, audio acquisition of the audio input may be ongoing, continuous audio encoding may be performed, by a streaming audio encoder, on the acquired audio stream. The streaming audio encoder 210 may be based on any suitable encoder architecture, which, by way of example only, may be a Mamba Streaming Encoder, or other audio encoder having a streaming encoding capability.

The machine-learning model 220 may be based on a language model (LM). The language model can have a question-and-answer capability by learning from a large corpus of corpora. The machine-learning model may also be based on other suitable models. Providing a specific configuration area in the creation process of the function allows the user to provide a prompt, and the configuration of the prompt may be completed in a natural language. In this way, the user can conveniently constrain the output of the model and configure diversified digital assistants. In some embodiments, the machine-learning model 220 may also be based on any suitable model structure, including but not limited to a Transformer model, a Convolutional Neural Network (CNN), a Recurrent Neural Network (RNN), a Deep Neural Network (DNN), and the like.

In an embodiment of the present disclosure, the machine-learning model 220 may obtain a system prompt 202, which may be in text form, for guiding the machine-learning model 220 to generate a text unit sequence 222 based on an audio feature sequence 212. As part of the input of the machine-learning model, the audio feature sequence 212 may be considered as audio prompt information for the machine-learning model. The text unit sequence 222 output by the machine-learning model 220 may be treated as a response text for the first audio stream 201. The text unit sequence 222 may include a series of text embeddings, or text tokens. The machine-learning model 220 is configured to generate the text unit sequence 222 based on a system prompt and the audio feature sequence 212 as a response to the first audio stream 201. In some embodiments, the streaming audio encoder 210 may encode the first audio stream 201 in real-time (i.e., in a streaming manner) into the audio feature sequence 212, which may be provided to the machine-learning model 220 in real-time.

The electronic device 110 may determine whether the text unit sequence 222 satisfies an audio synthesis condition, and generate, by the streaming audio synthesizer 230, a second audio stream 203 from the text unit sequence 222 for playback in response to the text unit sequence 222 satisfying the audio synthesis condition. In some embodiments, the streaming audio synthesizer 230 includes a streaming audio synthesis model 232 and a streaming audio decoder 234. The streaming audio synthesis model 232 may encode a plurality of audio encoding units (e.g., may be referred to as second audio encoding units) based on the text unit sequence 222. The streaming audio decoder 234 may decode the second audio stream 203 based on the plurality of second audio encoding units. It may be understood that, if the first audio stream 201 includes the questioning speech of the user, the second audio stream 203 may include a response audio stream for the questioning speech. Since in the scene of a full-duplex audio conversation, the machine-learning model 220 may continuously process the input audio stream, thereby continuously generating the text unit sequence for audio synthesis. Thus, a streaming audio synthesizer may be utilized for continuous synthesis of audio for playback.

In the architecture of FIG. 2, the machine-learning model 220 generates a text unit sequence based on the system prompt and the audio input (i.e., the audio feature sequence 212), and then the streaming audio synthesizer 230 generates a speech from the generated text unit sequence. It is desirable in a full-duplex scene to process both input stream and output stream simultaneously. However, text and audio generally have a large frame rate difference, which can result in the machine-learning model 220 outputting text at a larger frame rate than the streaming audio synthesizer 230 outputting audio. In some embodiments, it is proposed to synchronize the states of the input and output audio streams by combining a cycle to achieve periodic synchronization between the input and output streams.

In such a synchronization mechanism, the machine-learning model 220 is configured to generate a predetermined number of text units based on the audio feature sequence corresponding to a predetermined duration in response to the received audio feature sequence 212 being an audio feature sequence corresponding to the predetermined duration (e.g., which may be represented as Δt) in the first audio stream 201. That is, in response to receiving the audio feature sequence corresponding to the predetermined duration having been encoded by the streaming audio encoder 210 from the first audio stream 201, the machine-learning model 220 may generate a predetermined number of text units corresponding to the audio feature sequence corresponding to the predetermined duration. As such, in one cycle, the machine-learning model 220 may always provide a fixed input text unit to the streaming audio synthesizer 230.

It should be understood that the predetermined duration here may be any suitable duration, for example, 300 ms, 400 ms, 500 ms, etc., and the predetermined number herein may be any suitable number, for example, 2, 3, 4, etc. The predetermined duration and the predetermined number may be set based on actual conditions, which is not limited in the present disclosure.

In some embodiments, the audio feature sequence 212 output by the streaming encoder 210 may be input into the machine-learning model 220 through a cross-attention mechanism. Then, the text unit sequence of the reply content is generated, in a streaming manner, by the machine-learning model 220 for transmission to a subsequent streaming audio synthesizer to synthesize a reply audio in real time.

To enable the machine-learning model 220 to process, in a streaming manner, the audio feature sequence 212 to generate, in a streaming manner, the text unit sequence 222. The machine-learning model 220 is configured to sequentially generate the text unit sequence 222 in an autoregressive manner. For example, if the audio feature sequence 212 includes 3 audio encoding units (A, B, and C), the machine-learning model 220 may sequentially generate the text unit sequences 222 corresponding to the 3 audio encoding units. When generating each text unit, the machine-learning model 220 may determine the text unit corresponding to the current audio encoding unit based on the text unit corresponding to the previously input audio encoding unit and the current input audio encoding unit. For example, the machine-learning model 220 may generate a first text unit based on the audio encoding unit A and the system prompt, and then continue to generate the next text unit based on the audio encoding units A and B and the previously generated first text unit. For the autoregressive manner of the machine-learning model 220, in general, the input of the machine-learning model may include a model input and a previously generated text unit sequence. Then, the audio portion of the model input, in the full-duplex scene, continues to increase (because the streaming encoder), if the audio feature sequence and the previously generated text unit sequence continue to be input to the machine-learning model 220, which results in an increasing input length.

In order to control the length of the input sequence of the machine-learning model, in some embodiments, at least one further first audio encoding unit subsequent encoded in the first audio stream 201 may also be provided as an input to an intermediate layer of the machine-learning model 220, rather than as an original input to the machine-learning model 220. In such embodiments, the intermediate layer herein may be a processing block based on the cross-attention mechanism in the machine-learning model 220. In some embodiments, the audio feature sequence 212 (e.g., the audio feature sequence corresponding to the predetermined duration) encoded by the streaming audio encoder 210 is input into the processing block based on the cross-attention mechanism in the machine-learning model 220. The processing block based on the cross-attention mechanism may determine a cross-attention weight 214 to be applied to the audio feature sequence 212 in any suitable manner, and the cross-attention weight 214 may affect the output of the machine learning model 220. It can be understood that the higher the numerical value corresponding to the cross-attention weight 214, the greater the influence on the output of the machine-learning model 220. For example only, the processing block based on the cross-attention mechanism may apply a weight with a higher corresponding numerical value to the audio corresponding to the user question, and apply a weight with a smaller corresponding numerical value to the ambient noise.

The machine-learning model 220 may generate the text unit sequence 222 based on the cross-attention weight, the system prompt, and the audio feature sequence 212. In some embodiments, the audio feature sequence 212 of the first audio stream 201 may include a plurality of audio encoding units (e.g., may be referred to as a first audio encoding unit). Specifically, the machine-learning model 220 may generate at least one text unit in the text unit sequence 222 based on the system prompt and an encoded first audio encoding unit in the first audio stream 201. The generated at least one text unit may be provided as an input to the machine-learning model 220. The machine-learning model 220 may further process the generated at least one text unit and the at least one further first audio encoding unit to generate a next text unit in the text unit sequence 222.

As previously mentioned, the text unit sequence output by the machine-learning model 220 is input to the streaming audio synthesizer 230 for synthesizing the output audio stream. However, considering that in an actual conversation scene, it may not be desirable in certain cases to always output an audio segment, but rather the model is required to have a certain amount of pause time to think or may interrupt the audio that is being output. For example, while the user is speaking the model may be expected to receive the user's audio input in its entirety before beginning to output an answer and ask the next question, at which point the model may be expected to terminate the answer to the previous question. Therefore, it is expected to configure a certain policy in streaming input and output architecture to help achieve such conversation characteristic.

In some embodiments, the audio synthesis condition may indicate that the text unit sequence 222 includes a start token. That is, only after the machine-learning model 220 outputs a start token, the subsequently generated text unit is input to the streaming audio synthesizer 230. The streaming audio encoder 210 may encode a first audio feature sequence corresponding to the first audio segment in the first audio stream 201. The machine-learning model 220 may generate, in response to receiving the first audio feature sequence, a first text unit sequence excluding the start token based on the system prompt and the first audio feature sequence. That is, when the model listens to the audio input but does not output an audio reply, the start token will not be output. The machine-learning model 220 may further generate a start token in response to the subsequent audio segment being an audio segment corresponding to the questioning speech, where the sorting of the start token in the text unit sequence may be before the text unit corresponding to a starting moment of the questioning speech, and may inform the streaming audio synthesizer 230 that the subsequent text unit sequence is a text unit sequence corresponding to the questioning speech. In some embodiments, before outputting the start token, the text unit output by the machine-learning model 220 may not be constrained, that is, the machine-learning model 220 may select any other text unit other than the start token.

As an example, if the first audio stream 201 includes an audio segment A and an audio segment B, where the audio segment A includes only ambient noise, the audio segment B includes ambient noise and questioning speech, the streaming audio encoder 210 may encode the audio feature sequence A corresponding to the audio segment A and the audio feature sequence B corresponding to the audio segment B. The machine-learning model 220 generates a text unit sequence A based on the system prompt and the audio feature sequence A, and the text unit sequence A does not include a start token. The machine-learning model 220 generates a text unit sequence B including a start token based on the system prompt and the audio feature sequence B.

Since the first text unit sequence does not include a start token, it may be determined that the first text unit sequence fails to satisfy an audio generation condition. In this case, the machine-learning model 220 does not input the output first text unit sequence into the streaming audio synthesizer 230. In some embodiments, if it is determined that the text unit output by the machine-learning model 220 includes a start token, it may be determined that the text unit satisfies the audio generation condition, and the machine-learning model 220 may input the subsequently generated text unit into the streaming audio synthesizer 230 to start outputting the audio stream for playback.

In some embodiments, in a case where it is determined that the predetermined number of text units satisfy the audio generation condition, the duration of the audio segment generated by the streaming audio synthesizer 230 may also be a predetermined duration. That is, after the streaming audio encoder 210 encodes the audio feature sequence corresponding to the predetermined duration, the streaming audio synthesizer 230 may synthesize the audio segment of the predetermined duration based on the text unit corresponding to the audio feature sequence. In some embodiments, in order to ensure that the generated audio segment is also of a predetermined duration, when the predetermined number of text units is small, the electronic device 110 may add certain padding features (also referred to as padding units, padding feature units, etc.) to the text unit sequence, each padding feature being regarded as a dummy text unit.

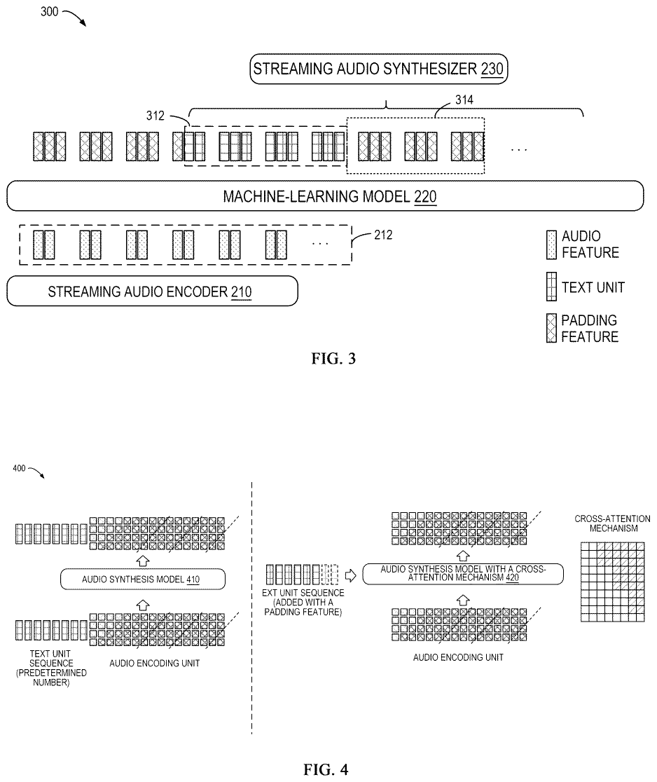

Referring to FIG. 3, in an example 300, the streaming audio encoder 210 may encode the audio feature sequence 212 corresponding to the predetermined duration, and the machine-learning model 220 may determine a text unit sequence 312 based on the system prompt and the audio feature sequence corresponding to the predetermined duration. The machine-learning model 220 may add a padding feature sequence 314 after the text unit sequence 312 in response to the number of text units included in the text unit sequence 312 being less. The streaming audio synthesizer 230 may generate an audio segment of the predetermined duration based on the text unit sequence 312 and the padding feature sequence 314, which may be understood that the content of the audio segment matches the content of the text unit sequence 312, and the padding feature sequence 314 does not affect the content of the audio segment. The electronic device 110 may consider the text unit sequence 312 and the padding feature sequence 314 together as a text unit sequence corresponding to the audio feature sequence 212 and provide them together to the streaming audio synthesizer 230.

In some embodiments, the streaming audio synthesizer 230 (which may be, for example, the streaming audio synthesis model 232) may include a processing block based on a cross-attention mechanism. The text unit sequence 222 output by the machine-learning model 220 is input to the processing block based on the cross-attention mechanism. The processing block, based on the cross-attention mechanism, may determine the cross-attention weight 224 to be applied to the text unit sequence 222 in any suitable manner, which may affect the output (i.e., the second audio stream 203) of the streaming audio synthesizer 230. It may be understood that the higher the value corresponding to the cross-attention weight 224, the greater the influence on the output of the streaming audio synthesizer 230. The streaming audio synthesizer 230 may generate the second audio stream 203 by the cross-attention weight and the text unit sequence 222.

In some embodiments, the streaming audio synthesis model 232 may be configured to sequentially generate a plurality of second audio encoding units in an autoregressive manner for synthesizing an audio stream. As an example, the electronic device 110 may provide the generated at least one second audio encoding unit as a first input of the streaming audio synthesis model 232, where the at least one second audio encoding unit is generated based on at least one text unit generated by the machine-learning model 220. Since the machine-learning model continuously outputs a text unit, under the autoregressive manner, the input of the streaming audio synthesis model may include a previously generated audio encoding unit and an increasing text unit sequence output by the machine-learning model. This also results in an increasing input length of the streaming audio synthesis model. In order to control the length of the input sequence of the streaming audio synthesis model, in some embodiments, the at least one text unit and subsequently generated at least one text unit generated by the machine-learning model 220 will be provided as a second input of an intermediate layer of the streaming audio synthesis model 232, rather than as the original input of the streaming audio synthesis model 232. The streaming audio synthesis model 232 may process the first input and the second input to generate a subsequent second audio encoding unit. The intermediate layer herein may be a processing block based on the cross-attention mechanism in the streaming audio synthesis model 232.

Referring to FIG. 4, as shown in an example 400, for a conventional audio synthesis model 410, a text unit sequence and an audio encoding unit are combined into a model input. Once the audio synthesis model 410 begins to generate an audio encoding unit based on the entire text unit sequence, it no longer receives new input, or the process of model processing will be interrupted. Therefore, it is difficult for the audio synthesis model 410 to process the incremental text input. For the audio synthesis model with a cross-attention mechanism 420, it may use the text unit sequence as text input, feed to the cross-attention, and use the audio encoding unit as decoder input. The audio synthesis model 420 may, for example, employ a stack of linear layers to transform the received input into a dimension that matches the codec of the audio synthesis model 420. That is, a padding feature may be added in the text unit sequence.

Referring back to FIG. 2, in some embodiments, as mentioned above, the streaming audio encoder 210 may encode the audio feature sequence corresponding to the predetermined duration, and the streaming audio synthesizer 230 may generate the audio segment corresponding to the predetermined duration. This audio segment may be played, and the audio segment being played may be captured for decoding by the streaming audio encoder 210. As shown in FIG. 2, the second audio stream 203 finally generated by the streaming audio synthesizer 230 may include a plurality of audio segments corresponding to a plurality of predetermined durations (for example, an audio segment out₀, an audio segment out₁, an audio segment out₂ shown in the figure). After the second audio stream 203 is played, the audio acquiring device in the environment acquires the played second audio stream 203. Therefore, the first audio stream 201 acquired from the environment may further include the played second audio stream 203. For example, as shown in FIG. 2, the audio segment in₁ acquired by the electronic device 110 includes the audio segment out₀. It may be understood that the first processing block in the machine-learning model 220 may determine a smaller weight for the second audio stream 203 played by the electronic device 110 itself.

In some embodiments, the electronic device 110 may also receive a new speech from the user during or after the electronic device 110 determines the second audio stream 203 based on the first audio stream 201. As shown in FIG. 2, in a process of generating the second audio stream 203 by the electronic device 110, the first audio stream 201 acquired in real time may further include a user audio stream. The user audio stream may be used, for example, to interrupt an audio conversation process of the electronic device 110. In this case, the electronic device 110 may generate, by the machine-learning model 220, a second text unit sequence including an interruption token based on the system prompt and the second audio feature sequence, in response to a second audio feature sequence corresponding to a second audio segment that has been encoded by the streaming audio encoder 210 from the first audio stream 201. The interruption token may indicate that a turn-taking event has occurred. For example, the electronic device 110 may determine a text unit after the interruption token fails satisfy the audio generation condition in response to determining that the second text unit sequence includes the interruption token, thereby preventing a text unit after the interruption token from being input into the streaming audio encoder 210.

The applications of the streaming audio encoder 210, the machine-learning model 220, and the streaming audio synthesizer 230 are described above, and the training processes of the streaming audio encoder 210, the machine-learning model 220, and the streaming audio synthesizer 230 are described below. The streaming audio encoder 210, the machine-learning model 220, and the streaming audio synthesizer 230 may be trained at the electronic device 110, or may be trained at other devices. In addition, the streaming audio encoder 210, the machine-learning model 220, and the streaming audio synthesizer 230 may be trained at the same device or separately at different devices. In this specification, the example description is made with only the streaming audio encoder 210, the machine-learning model 220, and the streaming audio synthesizer 230 being trained as an example at the electronic device 110.

The streaming audio encoder 210, the machine-learning model 220, and the streaming audio synthesizer 230 may include, for example, at least one phase of training process. As an example, the training process may include a first training phase and a second training phase. For example, the electronic device 110 may obtain a first sample audio and a first sample text unit sequence annotated for the first sample audio, and the annotated first sample text unit sequence may be a response to the first sample audio. That is, the first sample audio may be considered as a questioning audio, and the first sample text unit sequence is considered as a text unit sequence of the response text for the questioning audio.

The electronic device 110 may, during the first training phase, train the streaming audio encoder 210 and the machine-learning model 220 with a first sample audio and a first sample text unit sequence annotated for the first sample audio. After the first training phase, the streaming audio encoder 210 and the machine-learning model 220 may be aligned, so that the machine-learning model 220 has a speech understanding capability. During the second training phase, the electronic device 110 may train at least some of the model parameters of the streaming audio synthesizer 230 and of the machine-learning model 220 with the first sample audio and the first sample text unit sequence. The machine-learning model 220 over the second training phase may have a conversational capability.

In some embodiments, the electronic device 110 may determine both a text loss ((loss_{TTS}) and a model loss (loss_{LM}) in both training phases, which may respectively indicate the cross-entropy loss between texts and the cross-entropy loss between speeches. The total loss per training phase can be expressed as follows:

$$loss = {w}_{text} * {loss}_{LM} + {w}_{speech} * {loss}_{TTS} \qquad ( 1 )$$

where wₜₑₓₜ is the weight of loss_{LM} and W_{speech} is the weight of loss_{TTS}, and the two weights may respectively have different weight values in different training phases. For example, the value of wₜₑₓₜ differs between the first training phase and the second training phase. For example only, wₜₑₓₜ may be 0.1 and W_{speech} may be 1 in the first training phase, whereas wₜₑₓₜ may be 0 and W_{speech} may be 1 in the second training phase.

In each training phase, the electronic device 110 trains the model by minimizing loss, with the training target of driving loss below a predetermined value.

In summary, according to the embodiments of the present disclosure, a machine learning model can understand and generate audio in a full-duplex, streaming manner, without introducing discrete audio encoding. This may improve the performance and efficiency of the audio conversation.

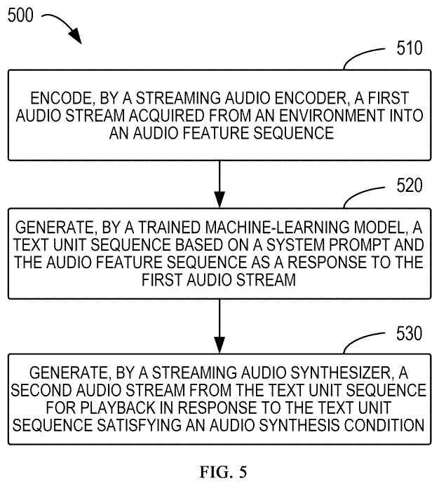

FIG. 5 shows a flowchart of a method 500 for an audio conversation according to some embodiments of the present disclosure. The method 500 may be implemented at the electronic device 110 of FIG. 1. The method 500 will be described with reference to the environment 100 of FIG. 1.

At block 510, the electronic device 110 encodes, by a streaming audio encoder, a first audio stream acquired from an environment into an audio feature sequence.

At block 520, the electronic device 110 generates, by a trained machine-learning model, a text unit sequence based on a system prompt and the audio feature sequence as a response to the first audio stream.

At block 530, the electronic device 110 generates, by a streaming audio synthesizer, a second audio stream from the text unit sequence for playback in response to the text unit sequence satisfying an audio synthesis condition.

In some embodiments, generating the text unit sequence based on the system prompt and the audio feature sequence includes: generating a predetermined number of text units by the machine-learning model in response to an audio feature sequence corresponding to a predetermined duration having been encoded by the audio encoder from the first audio stream; and where generating the second audio stream from the text unit sequence by the streaming audio synthesizer includes: generating, in response to the predetermined number of text units satisfying the audio synthesis condition, an audio segment in the second audio stream from the predetermined number of text units by the streaming audio synthesizer for playback, where a duration of the generated audio segment is the predetermined duration.

In some embodiments, the audio feature sequence of the first audio stream includes a plurality of first audio encoding units, and the machine-learning model is configured to sequentially generate the text unit sequence in an autoregressive manner, and generating the text unit sequence based on the system prompt and the audio feature sequence includes: generating at least one text unit in the text unit sequence by the machine-learning model, where the at least one text unit is determined based on the system prompt and an encoded first audio encoding unit in the first audio stream; providing the generated at least one text unit as an input to the machine-learning model; providing at least one further first audio encoding unit subsequent encoded in the first audio stream as an input to an intermediate layer of the machine-learning model; and processing, by the machine-learning model, the generated at least one text unit and the at least one further first audio encoding unit to generate a next text unit in the text unit sequence

In some embodiments, the audio synthesizer is configured to sequentially generate a plurality of second audio encoding units in an autoregressive manner, the second audio encoding unit being for decoding into the second audio stream, and generating the second audio stream from the text unit sequence by the streaming audio synthesizer includes: providing the generated at least one second audio encoding unit as a first input to the audio synthesizer, wherein the at least one second audio encoding unit is generated based on at least one text unit already generated by the machine-learning model; providing the at least one text unit already generated by the machine-learning model and at least one subsequently generated text unit as a second input to an intermediate layer of the audio synthesizer; and processing, by the audio synthesizer, the first input and the second input to generate a subsequent second audio encoding unit.

In some embodiments, the machine-learning model includes a first processing block based on a cross-attention mechanism, and where the audio feature sequence is input into the first processing block; and where the audio synthesizer includes a second processing block based on a cross-attention mechanism, and where the text unit sequence is input into the second processing block.

In some embodiments, generating the text unit sequence based on the system prompt and the audio feature sequence includes: generating, by the machine-learning model, a first text unit sequence excluding a start token based on the system prompt and the first audio feature sequence, in response to a first audio feature sequence corresponding to a first audio segment that has been encoded by the audio encoder from the first audio stream; and the method 500 further includes: determining that the first text unit sequence fails to satisfy an audio generation condition in response to determining that the first text unit sequence fails to include the start token; and preventing the first text unit sequence being input into the streaming audio decoder in response to determining that the first text unit sequence fails to satisfy the audio generation condition.

In some embodiments, generating the text unit sequence based on the system prompt and the audio feature sequence includes: generating, by the machine-learning model, a second text unit sequence including an interruption token based on the system prompt and the second audio feature sequence, in response to a second audio feature sequence corresponding to a second audio segment that has been encoded by the audio encoder from the first audio stream; and the method 500 further includes: determining that a text unit after the interruption token fails satisfy the audio generation condition in response to determining that the second text unit sequence includes the interruption token; and preventing a text unit after the interruption token from being input into the streaming audio encoder.

In some embodiments, a training process of the streaming audio encoder, the machine-learning model, and the streaming audio synthesizer includes a first training phase and a second training phase, where: during the first training phase, the streaming audio encoder and the machine-learning model are trained with a first sample audio and a first sample text unit sequence annotated for the first sample audio, where the annotated first sample text unit sequence is a response to the first sample audio; and during the second training phase, at least some of the model parameters of the streaming audio synthesizer and of the machine-learning model are trained with the first sample audio and the first sample text unit sequence annotated for the first sample audio

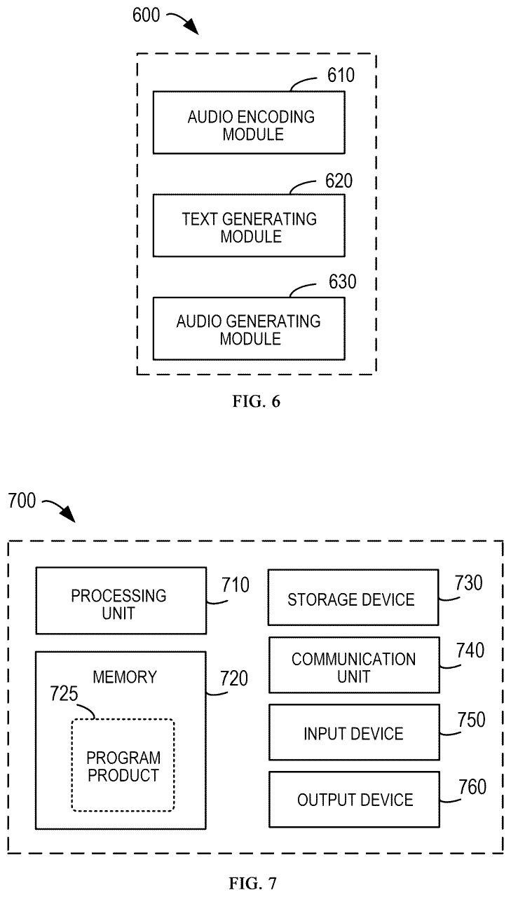

The embodiments of the present disclosure also provide a corresponding apparatus for implementing the above method or process. FIG. 6 illustrates an example structural block diagram of an apparatus 600 for an audio conversation according to some embodiments of the present disclosure. The apparatus 600 may be implemented or included in the electronic device 110. The various modules/components in the apparatus 600 may be implemented by hardware, software, firmware, or any combination thereof.

As shown in FIG. 6, the apparatus 600 includes an audio encoding module 610 configured to encode, by a streaming audio encoder, a first audio stream acquired from an environment into an audio feature sequence. The apparatus 600 further includes a text generating module 620 configured to generate, by a trained machine-learning model, a text unit sequence based on a system prompt and the audio feature sequence as a response to the first audio stream. The apparatus 600 further includes an audio generating module 630 configured to generate, by a streaming audio synthesizer, a second audio stream from the text unit sequence for playback in response to the text unit sequence satisfying an audio synthesis condition.

In some embodiments, the text generating module 620 is further configured to: generate a predetermined number of text units by the machine-learning model in response to an audio feature sequence corresponding to a predetermined duration having been encoded by the audio encoder from the first audio stream; and the audio generating module 630 is further configured to: generate, in response to the predetermined number of text units satisfying the audio synthesis condition, an audio segment in the second audio stream from the predetermined number of text units by the streaming audio synthesizer for playback, where a duration of the generated audio segment is the predetermined duration.

In some embodiments, the audio feature sequence of the first audio stream includes a plurality of first audio encoding units, and the machine-learning model is configured to sequentially generate the text unit sequence in an autoregressive manner, and the text generating module 620 is further configured to: generate at least one text unit in the text unit sequence by the machine-learning model, where the at least one text unit is determined based on the system prompt and an encoded first audio encoding unit in the first audio stream; provide the generated at least one text unit as an input to the machine-learning model; provide at least one further first audio encoding unit subsequent encoded in the first audio stream as an input to an intermediate layer of the machine-learning model; and process, by the machine-learning model, the generated at least one text unit and the at least one further first audio encoding unit to generate a next text unit in the text unit sequence.

In some embodiments, the audio synthesizer is configured to sequentially generate a plurality of second audio encoding units in an autoregressive manner, the second audio encoding unit being for decoding into the second audio stream, and the audio generating module 630 is further configured to: provide the generated at least one second audio encoding unit as a first input to the audio synthesizer, where the at least one second audio encoding unit is generated based on at least one text unit generated by the machine-learning model; provide the at least one text unit already generated by the machine-learning model and at least one subsequently generated text unit as a second input to an intermediate layer of the audio synthesizer; and process, by the audio synthesizer, the first input and the second input to generate a subsequent second audio encoding unit.

In some embodiments, the machine-learning model includes a first processing block based on a cross-attention mechanism, and where the audio feature sequence is input into the first processing block; and where the audio synthesizer includes a second processing block based on a cross-attention mechanism, and where the text unit sequence is input into the second processing block.

In some embodiments, the text generating module 620 is further configured to: generate, by the machine-learning model, a first text unit sequence excluding a start token based on the system prompt and the first audio feature sequence, in response to a first audio feature sequence corresponding to a first audio segment that has been encoded by the audio encoder from the first audio stream; and the apparatus 600 further includes: a first condition determining module configured to determine that the first text unit sequence fails to satisfy an audio generation condition in response to determining that the first text unit sequence fails to include the start token; and a first preventing module configured to prevent the first text unit sequence being input into the streaming audio decoder in response to determining that the first text unit sequence fails to satisfy the audio generation condition.

In some embodiments, the text generating module 620 is further configured to: generate, by the machine-learning model, a second text unit sequence including an interruption token based on the system prompt and the second audio feature sequence, in response to a second audio feature sequence corresponding to a second audio segment that has been encoded by the audio encoder from the first audio stream; and the apparatus 600 further includes: a second condition determining module configured to determine that a text unit after the interruption token fails satisfy the audio generation condition in response to determining that the second text unit sequence includes the interruption token; and a second preventing module configured to prevent a text unit after the interruption token from being input into the streaming audio encoder.

In some embodiments, a training process of the streaming audio encoder, the machine-learning model, and the streaming audio synthesizer includes a first training phase and a second training phase, where: during the first training phase, the streaming audio encoder and the machine-learning model are trained with a first sample audio and a first sample text unit sequence annotated for the first sample audio, where the annotated first sample text unit sequence is a response to the first sample audio; and during the second training phase, at least some of the model parameters of the streaming audio synthesizer and of the machine-learning model are trained with the first sample audio and the first sample text unit sequence annotated for the first sample audio

The units and/or modules included in the apparatus 600 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 600 may be implemented, at least in part, by one or more hardware logic components. By way of example and not limitation, example types of hardware logic components that may be used include Field-Programmable Gate Arrays (FPGAs), Application-Specific Integrated Circuits (ASICs), Application-Specific Standard Products (ASSPs), Systems on Chip (SoCs), Complex Programmable Logic Devices (CPLDs), and the like.

It should be understood that one or more steps in the methods described above may be performed by an appropriate electronic device or a combination of such electronic devices. Such an electronic device or combination may, for example, include the electronic device 110 shown in FIG. 1.

FIG. 7 illustrates a block diagram of an electronic device 700 in which one or more embodiments of the present disclosure may be implemented. It should be understood that the electronic device 700 illustrated in FIG. 7 is merely for example and should not constitute any limitation on the function and scope of the embodiments described herein. The electronic device 700 shown in FIG. 7 may be configured to implement the electronic device 110 in FIG. 1.

As shown in FIG. 7, the electronic device 700 is in a form of a general-purpose electronic device. Components of the electronic device 700 may include, but are not limited to, one or more processors or processing units 710, memory 720, storage device 730, one or more communication units 740, one or more input devices 750, and one or more output devices 760. The processing units 710 may be actual or virtual processors and are capable of performing various processes based on programs stored in the memory 720. In a multiprocessor system, a plurality of processing units perform computer-executable instructions in parallel to increase the parallel processing power of the electronic device 700.

The electronic device 700 typically includes a plurality of computer storage media. Such media may be any obtainable media accessible to the electronic device 700, including, but not limited to, volatile and non-volatile media, removable and non-removable media. The memory 720 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, a disk, or any other medium that may be capable of being used to store information and/or data and may be accessible within the electronic device 700.

The electronic device 700 may further include additional removable/non-removable, volatile/non-volatile storage media. Although not shown in FIG. 7, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not shown) by one or more data media interfaces. The memory 720 may include a computer program product 725 having one or more program modules that are configured to perform various methods or actions of various embodiments of the present disclosure.

The communication unit 740 implements communication with other electronic devices via a communication medium. Additionally, the functions of the components of the electronic device 700 may be implemented as a single computing cluster or a plurality of computing machines that are capable of communicating over a communication connection. Thus, the electronic device 700 may use logical connections to one or more other servers, networked personal computers (PCs), or one further network node to operate in a networked environment.

The input device 750 may be one or more input devices, such as a mouse, a keyboard, a tracking ball, and the like. The output device 760 may be one or more output devices, such as a monitor, a speaker, a printer, and the like. The electronic device 700 may also communicate, as desired, via the communication unit 740, with one or more external devices (not shown), external devices such as storage devices, display devices, etc., with one or more devices that enable a user to interact with the electronic device 700, or with any device that enables the electronic device 700 to communicate with one or more other electronic devices (e.g., a network card, modem, etc.) to communicate. Such communication may be performed via an input/output (I/O) interface (not shown).

According to example implementations of the present disclosure, a computer-readable storage medium having a computer program stored thereon is provided, the program, when performed by a processor, implementing the method described above. According to example implementations of the present disclosure, a computer program product is also provided, the computer program product being tangibly stored on a non-transitory computer-readable medium and including computer-executable instructions, and the computer-executable instructions being performed by a processor to implement the methods described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some updated implementations, the functions noted in the blocks may also occur in a different order than those noted in the figures. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for an audio conversation, comprising:
encoding, by a streaming audio encoder, a first audio stream acquired from an environment into an audio feature sequence;
generating, by a trained machine-learning model, a text unit sequence based on a system prompt and the audio feature sequence as a response to the first audio stream; and
generating, by a streaming audio synthesizer, a second audio stream from the text unit sequence for playback in response to the text unit sequence satisfying an audio synthesis condition.

2. The method of claim 1, wherein generating the text unit sequence based on the system prompt and the audio feature sequence comprises:
generating a predetermined number of text units by the machine-learning model in response to an audio feature sequence corresponding to a predetermined duration having been encoded by the audio encoder from the first audio stream; and
wherein generating the second audio stream from the text unit sequence by the streaming audio synthesizer comprises:
generating, in response to the predetermined number of text units satisfying the audio synthesis condition, an audio segment in the second audio stream from the predetermined number of text units by the streaming audio synthesizer for playback, wherein a duration of the generated audio segment is the predetermined duration.

3. The method of claim 1, wherein the audio feature sequence of the first audio stream comprises a plurality of first audio encoding units, and the machine-learning model is configured to sequentially generate the text unit sequence in an autoregressive manner, and wherein generating the text unit sequence based on the system prompt and the audio feature sequence comprises:
generating at least one text unit in the text unit sequence by the machine-learning model, wherein the at least one text unit is determined based on the system prompt and an encoded first audio encoding unit in the first audio stream;
providing the generated at least one text unit as an input to the machine-learning model;
providing at least one further first audio encoding unit subsequent encoded in the first audio stream as an input to an intermediate layer of the machine-learning model; and
processing, by the machine-learning model, the generated at least one text unit and the at least one further first audio encoding unit to generate a next text unit in the text unit sequence.

4. The method of claim 1, wherein the audio synthesizer is configured to sequentially generate a plurality of second audio encoding units in an autoregressive manner, the second audio encoding unit being for decoding into the second audio stream, and wherein generating the second audio stream from the text unit sequence by the streaming audio synthesizer comprises:
providing the generated at least one second audio encoding unit as a first input to the audio synthesizer, wherein the at least one second audio encoding unit is generated based on at least one text unit already generated by the machine-learning model;
providing the at least one text unit already generated by the machine-learning model and at least one subsequently generated text unit as a second input to an intermediate layer of the audio synthesizer; and
processing, by the audio synthesizer, the first input and the second input to generate a subsequent second audio encoding unit.

5. The method of claim 1, wherein the machine-learning model comprises a first processing block based on a cross-attention mechanism, and wherein the audio feature sequence is input into the first processing block; and
wherein the audio synthesizer comprises a second processing block based on a cross-attention mechanism, and wherein the text unit sequence is input into the second processing block.

6. The method of claim 1, wherein generating the text unit sequence based on the system prompt and the audio feature sequence comprises:
generating, by the machine-learning model, a first text unit sequence excluding a start token based on the system prompt and the first audio feature sequence, in response to a first audio feature sequence corresponding to a first audio segment that has been encoded by the audio encoder from the first audio stream; and
wherein the method further comprises:
determining that the first text unit sequence fails to satisfy an audio generation condition in response to determining that the first text unit sequence fails to comprise the start token; and
preventing the first text unit sequence being input into the streaming audio decoder in response to determining that the first text unit sequence fails to satisfy the audio generation condition.

7. The method of claim 1, wherein generating the text unit sequence based on the system prompt and the audio feature sequence comprises:
generating, by the machine-learning model, a second text unit sequence comprising an interruption token based on the system prompt and the second audio feature sequence, in response to a second audio feature sequence corresponding to a second audio segment that has been encoded by the audio encoder from the first audio stream; and
wherein the method further comprises:
determining that a text unit after the interruption token fails satisfy the audio generation condition in response to determining that the second text unit sequence comprises the interruption token; and
preventing a text unit after the interruption token from being input into the streaming audio encoder.

8. The method of claim 1, wherein a training process of the streaming audio encoder, the machine-learning model, and the streaming audio synthesizer comprises a first training phase and a second training phase, wherein:
during the first training phase, the streaming audio encoder and the machine-learning model are trained with a first sample audio and a first sample text unit sequence annotated for the first sample audio, wherein the annotated first sample text unit sequence is a response to the first sample audio; and
during the second training phase, at least some of the model parameters of the streaming audio synthesizer and of the machine-learning model are trained with the first sample audio and the first sample text unit sequence annotated for the first sample audio.

9. An electronic device, comprising:
at least one processor; and
at least one memory coupled to the at least one processor and storing instructions for execution by the at least one processor, the instructions, when executed by the at least one processor, causing the device to perform operations comprising:
encoding, by a streaming audio encoder, a first audio stream acquired from an environment into an audio feature sequence;
generating, by a trained machine-learning model, a text unit sequence based on a system prompt and the audio feature sequence as a response to the first audio stream; and
generating, by a streaming audio synthesizer, a second audio stream from the text unit sequence for playback in response to the text unit sequence satisfying an audio synthesis condition.

10. The electronic device of claim 9, wherein generating the text unit sequence based on the system prompt and the audio feature sequence comprises:
generating a predetermined number of text units by the machine-learning model in response to an audio feature sequence corresponding to a predetermined duration having been encoded by the audio encoder from the first audio stream; and
wherein generating the second audio stream from the text unit sequence by the streaming audio synthesizer comprises:
generating, in response to the predetermined number of text units satisfying the audio synthesis condition, an audio segment in the second audio stream from the predetermined number of text units by the streaming audio synthesizer for playback, wherein a duration of the generated audio segment is the predetermined duration.

11. The electronic device of claim 9, wherein the audio feature sequence of the first audio stream comprises a plurality of first audio encoding units, and the machine-learning model is configured to sequentially generate the text unit sequence in an autoregressive manner, and wherein generating the text unit sequence based on the system prompt and the audio feature sequence comprises:
generating at least one text unit in the text unit sequence by the machine-learning model, wherein the at least one text unit is determined based on the system prompt and an encoded first audio encoding unit in the first audio stream;
providing the generated at least one text unit as an input to the machine-learning model;
providing at least one further first audio encoding unit subsequent encoded in the first audio stream as an input to an intermediate layer of the machine-learning model; and
processing, by the machine-learning model, the generated at least one text unit and the at least one further first audio encoding unit to generate a next text unit in the text unit sequence.

12. The electronic device of claim 9, wherein the audio synthesizer is configured to sequentially generate a plurality of second audio encoding units in an autoregressive manner, the second audio encoding unit being for decoding into the second audio stream, and wherein generating the second audio stream from the text unit sequence by the streaming audio synthesizer comprises:
providing the generated at least one second audio encoding unit as a first input of the audio synthesizer, wherein the at least one second audio encoding unit is generated based on at least one text unit generated by the machine-learning model;
providing the at least one text unit and subsequently generated at least one text unit generated by the machine-learning model as a second input of an intermediate layer of the audio synthesizer; and
processing, by the audio synthesizer, the first input and the second input to generate a subsequent second audio encoding unit.

13. The electronic device of claim 9, wherein the machine-learning model comprises a first processing block based on a cross-attention mechanism, and wherein the audio feature sequence is input into the first processing block; and
wherein the audio synthesizer comprises a second processing block based on a cross-attention mechanism, and wherein the text unit sequence is input into the second processing block.

14. The electronic device of claim 9, wherein generating the text unit sequence based on the system prompt and the audio feature sequence comprises:
generating, by the machine-learning model, a first text unit sequence excluding a start token based on the system prompt and the first audio feature sequence, in response to a first audio feature sequence corresponding to a first audio segment that has been encoded by the audio encoder from the first audio stream; and
wherein the operations further comprise:
determining that the first text unit sequence fails to satisfy an audio generation condition in response to determining that the first text unit sequence fails to comprise the start token; and
preventing the first text unit sequence being input into the streaming audio decoder in response to determining that the first text unit sequence fails to satisfy the audio generation condition.

15. The electronic device of claim 9, wherein generating the text unit sequence based on the system prompt and the audio feature sequence comprises:
generating, by the machine-learning model, a second text unit sequence comprising an interruption token based on the system prompt and the second audio feature sequence, in response to a second audio feature sequence corresponding to a second audio segment that has been encoded by the audio encoder from the first audio stream; and
wherein the operations further comprise:
determining that a text unit after the interruption token fails satisfy the audio generation condition in response to determining that the second text unit sequence comprises the interruption token; and
preventing a text unit after the interruption token from being input into the streaming audio encoder.

16. The electronic device of claim 9, wherein a training process of the streaming audio encoder, the machine-learning model, and the streaming audio synthesizer comprises a first training phase and a second training phase, wherein:
during the first training phase, the streaming audio encoder and the machine-learning model are trained with a first sample audio and a first sample text unit sequence annotated for the first sample audio, wherein the annotated first sample text unit sequence is a response to the first sample audio; and
during the second training phase, at least some of the model parameters of the streaming audio synthesizer and of the machine-learning model are trained with the first sample audio and the first sample text unit sequence annotated for the first sample audio.

17. A non-transitory computer-readable storage medium having computer instructions stored thereon, the computer instructions, when executed by a processor, implementing operations comprising:
encoding, by a streaming audio encoder, a first audio stream acquired from an environment into an audio feature sequence;
generating, by a trained machine-learning model, a text unit sequence based on a system prompt and the audio feature sequence as a response to the first audio stream; and
generating, by a streaming audio synthesizer, a second audio stream from the text unit sequence for playback in response to the text unit sequence satisfying an audio synthesis condition.

18. The non-transitory computer-readable storage medium of claim 17, wherein generating the text unit sequence based on the system prompt and the audio feature sequence comprises:
generating a predetermined number of text units by the machine-learning model in response to an audio feature sequence corresponding to a predetermined duration having been encoded by the audio encoder from the first audio stream; and
wherein generating the second audio stream from the text unit sequence by the streaming audio synthesizer comprises:
generating, in response to the predetermined number of text units satisfying the audio synthesis condition, an audio segment in the second audio stream from the predetermined number of text units by the streaming audio synthesizer for playback, wherein a duration of the generated audio segment is the predetermined duration.

19. The non-transitory computer-readable storage medium of claim 17, wherein the audio feature sequence of the first audio stream comprises a plurality of first audio encoding units, and the machine-learning model is configured to sequentially generate the text unit sequence in an autoregressive manner, and wherein generating the text unit sequence based on the system prompt and the audio feature sequence comprises:
generating at least one text unit in the text unit sequence by the machine-learning model, wherein the at least one text unit is determined based on the system prompt and an encoded first audio encoding unit in the first audio stream;
providing the generated at least one text unit as an input to the machine-learning model;
providing at least one further first audio encoding unit subsequent encoded in the first audio stream as an input to an intermediate layer of the machine-learning model; and
processing, by the machine-learning model, the generated at least one text unit and the at least one further first audio encoding unit to generate a next text unit in the text unit sequence.

20. The non-transitory computer-readable storage medium of claim 17, wherein the audio synthesizer is configured to sequentially generate a plurality of second audio encoding units in an autoregressive manner, the second audio encoding unit being for decoding into the second audio stream, and wherein generating the second audio stream from the text unit sequence by the streaming audio synthesizer comprises:
providing the generated at least one second audio encoding unit as a first input of the audio synthesizer, wherein the at least one second audio encoding unit is generated based on at least one text unit generated by the machine-learning model;
providing the at least one text unit and subsequently generated at least one text unit generated by the machine-learning model as a second input of an intermediate layer of the audio synthesizer; and
processing, by the audio synthesizer, the first input and the second input to generate a subsequent second audio encoding unit.
